(19) United States
(12) Patent Application Publication
(10) Pub. No.: US 2024/0404092 A1
(43) Pub. Date: Dec. 5, 2024

(54) IMAGE PROCESSING DEVICE, METHOD AND PROGRAM

(71) Applicant: NIPPON TELEGRAPH AND TELEPHONE CORPORATION, Tokyo (JP)

(72) Inventors: Takashi SANO, Musashino-shi, Tokyo (JP); Masato ONO, Musashino-shi, Tokyo (JP); Yumi KIKUCHI, Musashino-shi, Tokyo (JP); Shinji FUKATSU, Musashino-shi, Tokyo (JP)

(73) Assignee: NIPPON TELEGRAPH AND TELEPHONE CORPORATION, Tokyo (JP)

(21) Appl. No.: 18/687,312

(22) PCT Filed: Aug. 30, 2021
(86) PCT No.: PCT/JP2021/031720

§ 371 Date: Feb. 28, 2024

(51) Int. Cl. G06T 7/579; G06T 5/20; G06T 5/70; G06T 7/11

(52) U.S. Cl. CPC G06T 7/579; G06T 5/20; G06T 5/70; G06T 7/11; G06T 2207/20192

(57) ABSTRACT

According to an aspect of the present invention, when a depth map of a moving image is generated from the moving image, first filtering of performing edge-preserving smoothing on first depth map information generated for each of a plurality of frames constituting the moving image by using segmentation information generated separately and second filtering of smoothing, in a time direction, a pixel value of a pixel corresponding to a position coordinate in a frame of the first depth map information in the plurality of frames are performed to generate corrected second depth map information.

### TECHNICAL FIELD

An aspect of the present invention relates to a video information processing apparatus, a method, and a program used to generate a three-dimensional moving image, for example.

### BACKGROUND ART

As one of the methods for generating a three-dimensional image, there is a method called a depth map in which information of a distance from a viewpoint is mapped and represented in gradation expression with a position on the far side and a position on the near side set as both ends. In addition, a method of generating a more accurate depth map by combining depth information of a depth map with segmentation information obtained by dividing an image of an object in an image frame into a plurality of areas in a two-dimensional direction has also been proposed.

However, in a case where this depth map generation method is directly applied to video information of a moving image or the like without change, the depth map is independently generated for each frame without considering a correlation between frames. Thus, the gradations of the object in the image in the depth direction change in each frame, and when the generated depth map is viewed as a moving image, the object appears to sway in the depth direction, resulting in an unnatural moving image.

Thus, for example, a method of performing smoothing processing in the time direction while preserving the edges of an object in frames that are continuous in the time direction by using a motion-compensated temporal filter has been proposed (e.g., see Patent Literature 1). In this method, for example, an image of an object is divided into a plurality of pixel blocks for each frame, and processing of predicting a motion in the image of the object is performed on each pixel block, thereby enabling smoothing of the moving image in the time direction.

### CITATION LIST

### Patent Literature

Patent Literature 1: JP 2009-55146 A

### SUMMARY OF INVENTION

### Technical Problem

However, in the method disclosed in Patent Literature 1, the processing of predicting motions in the moving image of the object is performed for each of the plurality of divided pixel blocks. For this reason, the problem that the method causes a significant increase in the processing load on the device and thus is not suitable for practical use arises.

The present invention has been conceived focusing on this problem, and aims to provide a technique of enabling smoothing in the time direction while preserving the edges of an object in a moving image with less processing load.

### Solution to Problem

In order to solve the above problem, one aspect of a video information processing apparatus or a video information processing method according to the present invention is, when a depth map of a moving image is generated from the moving image, to acquire first depth map information generated for each of a plurality of frames constituting the moving image and acquire segmentation information generated by dividing an image area including an object into a plurality of pixel blocks for each of the plurality of frames constituting the moving image. In addition, by performing first filtering of performing edge-preserving smoothing on the first depth map information using the segmentation information as a guide image for each of the plurality of frames and performing second filtering of smoothing, in a time direction, a pixel value of a pixel corresponding to a position in the first depth map information in the plurality of frames, corrected second depth map information may be generated.

According to one aspect of the present invention, first filtering of performing edge-preserving smoothing and second filtering of smoothing a pixel value of a pixel corresponding to the first depth map information in the respective frames in a time direction are performed on the first depth map information generated for each of a plurality of frames. Thus, the fluctuation of the first depth map information in the time direction in each of the frames is reduced due to the second filtering, and even if the edge portions of the image of the object becomes unsharp due to the second filtering, the edge portions become sharp due to the first filtering. Therefore, it is possible to generate depth map information in which blurring or the like at the edge portions in the image of the object is curbed and fluctuations in the interframe correlation are reduced. Moreover, since the above-described sharpening of the edge portions and the curbed fluctuations in the time direction are realized by combining the smoothing processing in the time direction and the edge-preserving smoothing processing, the processing of predicting a motion for each pixel block becomes unnecessary, and thereby the above effects can be obtained with less processing load.

### Advantageous Effects of Invention

That is, according to one aspect of the present invention, it is possible to provide a technique that enables smoothing in a time direction while preserving an edge of an object in a moving image with less processing load.

### BRIEF DESCRIPTION OF DRAWINGS

FIG. 1 is a block diagram illustrating an example of a hardware configuration of a video information processing apparatus according to an embodiment of the invention.

FIG. 2 is a block diagram illustrating an example of a software configuration of the video information processing apparatus according to an embodiment of the invention.

FIG. 3 is a block diagram illustrating a more detailed configuration of the smoothing processing part illustrated in FIG. 2.

FIG. 4 is a diagram illustrating a first example of a frame used for smoothing processing by a temporal filter.

FIG. 5 is a flowchart showing a processing procedure and processing details of a depth map generation process executed by a control part of the video information processing apparatus illustrated in FIG. 2.

FIG. 6 is a flowchart showing a more detailed processing procedure and processing details of the smoothing processing in the processing procedure shown in FIG. 5.

FIG. 7 is a diagram illustrating a second example of a frame used for smoothing processing by a temporal filter.

### DESCRIPTION OF EMBODIMENTS

Hereinafter, embodiments according to the present invention will be described with reference to the drawings.

### One Embodiment

### Configuration Example

A video information processing apparatus according to an embodiment of the present invention has a function of generating a depth map for generating a parallax image in a display system that displays a three-dimensional moving image.

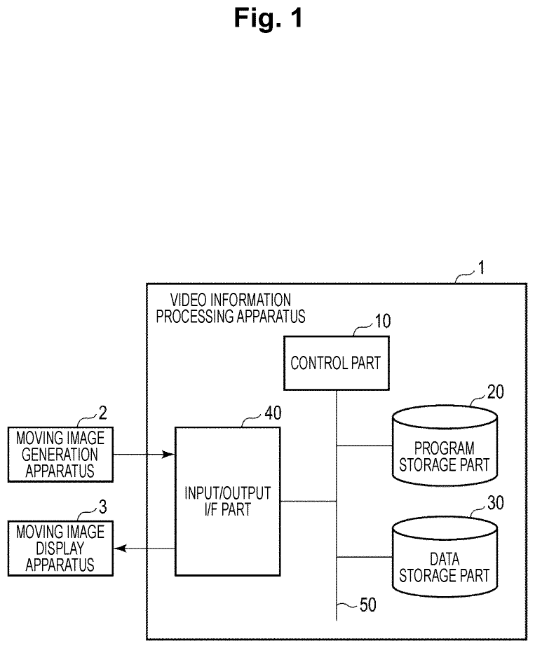

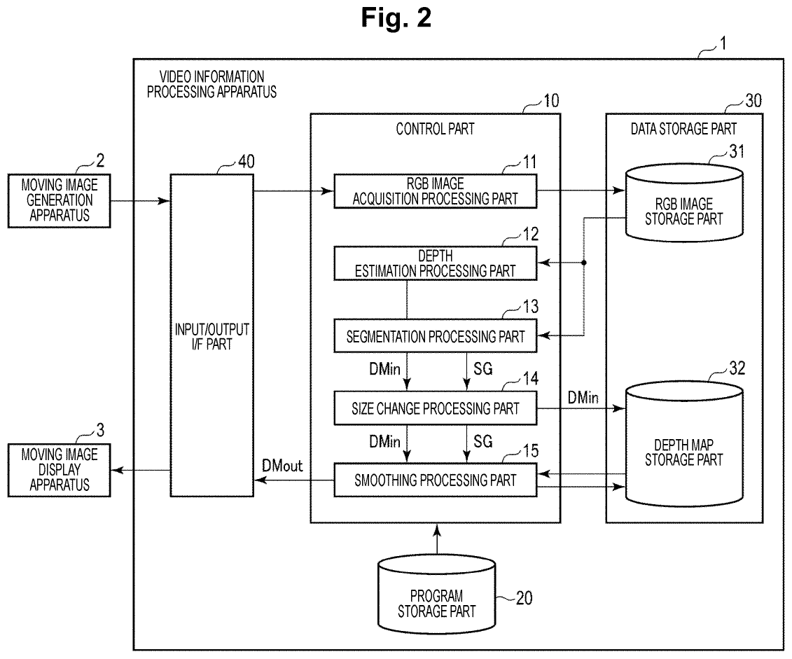

FIG. 1 and FIG. 2 are block diagrams respectively illustrating an example of a hardware configuration and an example of a software configuration of a video information processing apparatus 1 according to an embodiment of the present invention.

The video information processing apparatus 1 is configured by, for example, a general-purpose personal computer, and includes a control part 10 that uses a hardware processor such as a central processing unit (CPU). A storage unit having a program storage part 20 and a data storage part 30 and an input/output I/F part 40 are connected to the control part 10 via a bus 50.

Further, the control part 10 may include a graphics processing unit (GPU) in addition to the CPU. Furthermore, a communication I/F part for performing communication with an external device via a network may be connected to the control part 10. Moreover, the video information processing apparatus 1 may be an application specific integrated circuit (ASIC) for image processing, or may be a server apparatus arranged on a web or a cloud in some cases.

The input/output I/F part 40 is connected to a moving image generation apparatus 2 and a moving image display apparatus 3 that are external apparatuses. Further, when the moving image generation apparatus 2 and the moving image display apparatus 3 are installed in at a distance, the moving image generation apparatus 2 and the moving image display apparatus 3 may be connected to a communication I/F part of the video information processing apparatus 1.

The moving image generation apparatus 2 includes, for example, a camera, and generates and outputs a moving image. The moving image display apparatus 3 includes a display device or a projector using liquid crystal or organic EL, generates a three-dimensional moving image including a parallax image using a depth map generated by the video information processing apparatus 1, and displays the generated three-dimensional moving image on the display device.

For example, the program storage part 20 is configured by combining a non-volatile memory capable of writing and reading as needed, such as a hard disk drive (HDD) or a solid state drive (SSD), and a non-volatile memory such as a read only memory (ROM) as a storage medium, and stores various programs required for executing various control processes according to an embodiment of the present invention, in addition to middleware such as an operating system (OS).

The data storage part 30 is configured by combining, for example, a non-volatile memory capable of writing and reading as needed, such as an HDD or an SSD with a volatile memory such as a random access memory (RAM) as a storage medium and includes an RGB image storage part 31 and a depth map storage part 32 as a main data storage area necessary for implementing an embodiment of the present invention.

The RGB image storage part 31 is used to sequentially store RGB images of each frame of the moving image output from the moving image generation apparatus 2. The depth map storage part 32 is used as a video buffer, and temporarily stores depth maps for a plurality of frames to be used by the control part 10 for performing smoothing processing on the depth maps in the time direction by using a temporal filter.

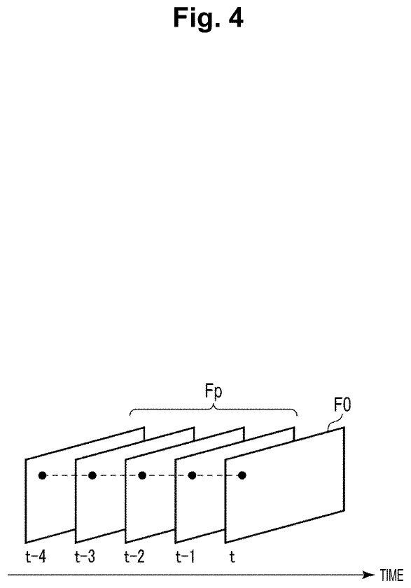

Here, the number of frames to be stored in the depth map storage part 32 is set according to the number of taps of the temporal filter. In general, although the number of taps of the temporal filter can be arbitrarily set according to the buffer amount of the depth map storage part 32 or the requirements for a processing delay of the entire system, it is set to, for example, about 5. Thus, in this case, the number of frames stored in the depth map storage part 32 is set to 5 as illustrated in FIG. 4.

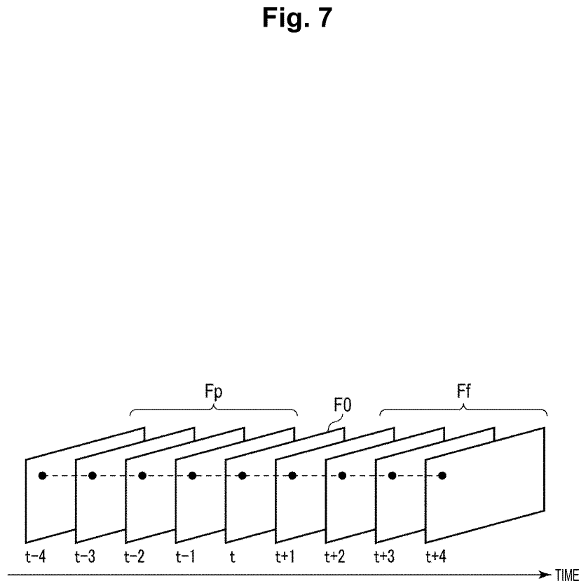

Furthermore, the frames stored in the depth map storage part 32 are not limited to the past frames Fp of the processing target frame F0 as illustrated in FIG. 4, and for example, a plurality of future frames Ff may be added to a plurality of past frames Fp of the processing target frames F0 as illustrated in FIG. 7.

Further, the data storage part 30 also has a storage area in which a depth map and a segmentation result generated in the course of a series of processing operations by the control part 10 are temporarily stored or an area in which various thresholds to be used in smoothing processing are stored.

The control part 10 includes an RGB image acquisition processing part 11, a depth estimation processing part 12, a segmentation processing part 13, a size change processing part 14, and a smoothing processing part 15 as processing functions according to an embodiment of the present invention. All of the above processing parts 11 to 15 are implemented by causing the processor such as the CPU and the GPU of the control part 10 to execute an application program stored in the program storage part 20.

The RGB image acquisition processing part 11 performs processing of receiving the RGB images of each frame constituting the moving image output from the moving image generation apparatus 2 via the input/output I/F part 40 and storing the RGB images in the RGB image storage part 31.

The depth estimation processing part 12 reads the RGB images for each frame from the RGB image storage part 31, and estimates and outputs a depth map from the read RGB images. The depth map is image data in which the depth of each pixel is expressed with, for example, 256 gradations of gray from 0 to 255. For example, the gradations are set to 0 at the far end and 255 at the near end, but may be gradations other than 256 gradations. For estimating a depth map, for example, a method called Depth from Videos in the Wild is used.

The segmentation processing part 13 reads the RGB images for each frame from the RGB image storage part 31, detects an object such as a moving object from the read RGB images, and outputs segmentation information obtained by dividing, for example, a rectangular image area including the detected object into a plurality of blocks in units of pixels. The segmentation information includes data in which a segment ID is assigned to each divided block of the pixels. For the segmentation processing, for example, a technique called Mask R-CNN can be used.

The size change processing part 14 inputs the depth map and the segmentation information from the depth estimation processing part 12 and the segmentation processing part 13, respectively. Then, the size of the depth map and the size of the segmentation information are changed so that the sizes thereof become the same size, and the depth map and the segmentation information with the changed size are output.

The smoothing processing part 15 inputs the depth map and the segmentation information with the size changed by the size change processing part 14 for each frame. Then, the smoothing processing part 15 performs smoothing processing on the input depth map in a two-dimensional direction using an edge-preserving smoothing filter, performs smoothing processing thereon in the time direction using the depth map of another frame stored in the depth map storage part 32 using the temporal filter, and outputs the depth map corrected in the smoothing processing. Further, an example of the smoothing processing on the depth map using the edge-preserving smoothing filter and the temporal filter will be described in detail in the operation example.

### OPERATION EXAMPLE

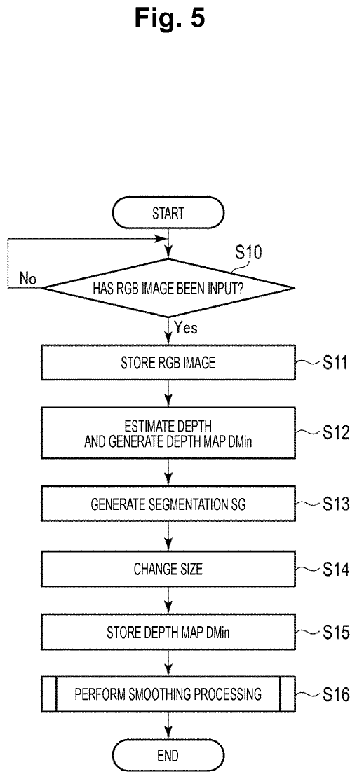

Next, an operation example of the video information processing apparatus 1 configured as described above will be described. FIG. 5 is a flowchart showing an overall processing procedure and processing details by the control part 10 of the video information processing apparatus 1.

### (1) Acquisition of RGB Image

In step S10, the control part 10 of the video information processing apparatus 1 monitors whether there is an input of an RGB image. In this state, when RGB images of a plurality of frames constituting a moving image are input from the moving image generation apparatus 2, the control part 10 of the video information processing apparatus 1 takes the RGB images of the respective frames via the input/output I/F part 40 under control of the RGB image acquisition processing part 11, and sequentially stores the taken RGB images in the RGB image storage part 31 in step S11.

Further, the RGB image acquisition processing part 11 may perform processing of separating and extracting the RGB images from the input moving image for each frame.

### (2) Depth Estimation

When the RGB images are input, the control part 10 of the video information processing apparatus 1 reads the RGB images from the RGB image storage part 31 for each frame in step S12 under control of the depth estimation processing part 12, performs depth estimation on the read RGB images to generate a depth map DMin, and outputs the depth map to the size change processing part 14. The depth map is image data in which the depth of each pixel of the RGB images is expressed by, for example, 256 gradations of gray from 0 to 255 as described above.

### (3) Generation of Segmentation Information

The control part 10 of the video information processing apparatus 1 performs segmentation processing on the RGB images in step S13 under control of the segmentation processing part 13 in parallel with the depth map estimation processing. For example, the segmentation processing part 13 first detects all objects such as a moving object from the RGB images. Then, for each detected object, for example, a rectangular image area including the object is divided into a plurality of pixel blocks in units of pixels, and a segment ID is assigned to each of the divided pixel blocks. For example, in a case where the image area is divided into 9 pixel blocks, 1 to 9 segment IDs are assigned to the pixel blocks. Then, the segmentation processing part 13 outputs segmentation information SG including the segment IDs for each frame to the size change processing part 14.

### (4) Change of Size

Subsequently, in step S14, the control part 10 of the video information processing apparatus 1 performs processing of changing the size of the depth map DMin and the segmentation information SG output from the depth estimation processing part 12 and the segmentation processing part 13, respectively, under control of the size change processing part 14 so that the frame sizes are the same.

In general, the depth estimation processing and the segmentation processing are often performed using an image obtained by reducing the original RGB image. This is because, when the reduced RGB image is used, processing costs for the depth map estimation processing and the segmentation processing are reduced and each processing time is shortened, and as a result, the processing time in the entire system can be shortened.

The size change processing part 14 changes the sizes of the depth map DMin and the segmentation information SG to, for example, the same size as the original RGB image in order to cope with a case where the sizes of the depth map DMin and the segmentation information SG are different due to the influence of the reduction processing described above. Further, in a case where the depth map DMin and the segmentation information SG have the same size, the size change processing is omitted.

The size change processing part 14 outputs the size-changed depth map DMin and segmentation information SG to the smoothing processing part 15. In addition, in step S 15, the size change processing part 14 stores the size-changed depth map DMin in the depth map storage part 32 in order to make the size-changed depth map DMin subject to smoothing processing in the time direction by a temporal filter to be described later.

### (5) Smoothing Processing

Next, the control part 10 of the video information processing apparatus 1 executes smoothing processing on the depth map output from the size change processing part 14 in step S16 as described below under control of the smoothing processing part 15.

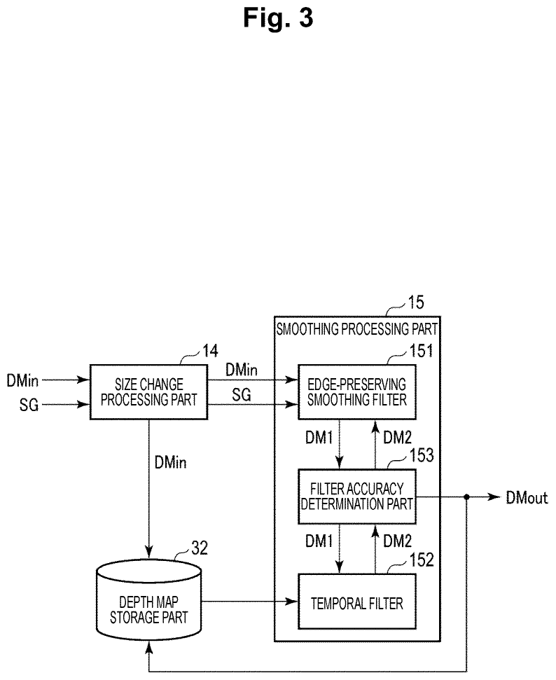

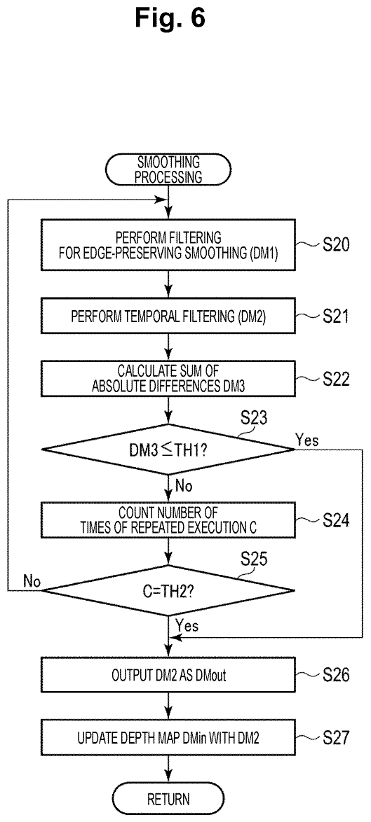

FIG. 3 is a block diagram illustrating an example of a functional configuration of the smoothing processing part 15, and FIG. 6 is a flowchart showing an example of a processing procedure and processing details of smoothing processing by the smoothing processing part 15.

The smoothing processing part 15 includes an edge-preserving smoothing filter 151, a temporal filter 152, and a filter accuracy determination part 153 as processing functions thereof. All of these processing functions 151 to 153 are realized by causing a processor such as a CPU or a GPU to execute a program.

### (5-1) First Smoothing Processing

First, in step S20, the smoothing processing part 15 performs filtering for edge-preserving smoothing on the input size-changed depth map DMin using the segmentation information SG of the same frame as a guide by using the edge-preserving smoothing filter 151. For this edge-preserving smoothing processing, for example, a Joint Bilateral Filter or a Guided Filter is used, but other filters can also be used.

When the filtering for the depth map DMin is the first time, the edge-preserving smoothing filter 151 transfers the filtered depth map DM1 to the temporal filter 152 via the filter accuracy determination part 153. Further, at this time, the filter accuracy determination part 153 temporarily stores the edge-preserving smoothing-processed depth map DM1 in the buffer area of the data storage part 30.

Next, in step S21, the smoothing processing part 15 uses the depth maps of a plurality of past frames stored in the depth map storage part 32 for the edge-preserving smoothing-processed depth map DM1 with the temporal filter 152 to perform smoothing processing on the pixel value in the time direction for each pixel corresponding to the coordinate position in the frame.

For example, when the frame F0 at a time t is the processing target as illustrated in FIG. 4, the pixel values are smoothed in the time direction for each pixel corresponding to the position coordinate in the frame using each depth map of four frames Fp at past times t−1, t−2, t−3, and t−4 with respect to the depth map of the frame F0. For example, a low-pass filter is used for the smoothing processing. A smoothing-processed depth map DM2 is returned from the temporal filter 152 to the filter accuracy determination part 153.

Subsequently, in step S22, the smoothing processing part 15 calculates the sum of absolute differences DM3 between the depth map DM2 output from the temporal filter 152 and the depth map DM1 output from the edge-preserving smoothing filter 151 and before being supplied to the temporal filter 152 under control of the filter accuracy determination part 153.

In step S23, the filter accuracy determination part 153 compares the calculated sum of absolute differences DM3 with a threshold TH1 stored in advance in a threshold storage area of the data storage part 30 and determines whether the sum of absolute differences DM3 is equal to or less than the threshold TH1. Then, when the sum of absolute differences DM3 is equal to or less than the threshold TH1, the depth map DM2 output from the temporal filter 152 is output as it is as a corrected depth map DMout in step S26.

Also, along with the operation, in step S27, the smoothing processing part 15 outputs the corrected depth map DMout to the depth map storage part 32, and updates the depth map Din of the corresponding frame F0 stored until then with the corrected depth map DMout.

### (5-2) Repeated Execution of Smoothing Processing

On the other hand, when the smoothing processing is performed by the temporal filter 152, the image at the edge portion of an object may be unsharp as if it were blurred or foggy, and in this case, the sum of absolute differences DM3 is not equal to or less than the threshold TH1.

Thus, as a result of the determination in step S23, if the sum of absolute differences DM3 is not equal to or less than the threshold TH1, the filter accuracy determination part 153 performs control to limit the repeated execution processing to be described later in steps S24 and S25, and then passes the depth map DM2 output from the temporal filter 152 to the edge-preserving smoothing filter 151 to perform the edge-preserving smoothing processing again.

In step S20, the edge-preserving smoothing filter 151 performs edge-preserving smoothing processing on the depth map DM2. That is, second edge-preserving smoothing processing is performed here. Then, the filter accuracy determination part 153 temporarily stores the depth map DM1 subjected to the second edge-preserving smoothing processing by the edge-preserving smoothing filter 151 in the buffer area of the data storage part 30, and then transfers the depth map DM1 to the temporal filter 152.

The temporal filter 152 performs second temporal filtering on the depth map DM1 in step S21, and returns the filtered depth map DM2 to the filter accuracy determination part 153.

In step S22, the filter accuracy determination part 153 calculates the sum of absolute differences DM3 between the depth map DM2 subjected to the second temporal filtering and the depth map DM1 before being subjected to the temporal filtering, and determines again whether the calculated sum of absolute differences DM3 is equal to or less than the threshold TH1 in step S23. Then, if the sum of absolute differences DM3 is equal to or less than the threshold TH1, the depth map DM2 after the second temporal filtering is output as a corrected depth map DMout in step S26.

On the other hand, if the sum of absolute differences DM3 is not equal to or less than the threshold TH1 yet, the filter accuracy determination part 153 returns the depth map DM2 to the edge-preserving smoothing filter 151 and causes the edge-preserving smoothing processing to be performed again. Thereafter, similarly, the edge-preserving smoothing processing by the edge-preserving smoothing filter 151 and the smoothing processing in the time direction by the temporal filter 152 are alternately and repeatedly executed on the depth map DM2 until the sum of absolute differences DM3 becomes equal to or less than the threshold TH1.

### (5-3) Limitation of Repeated Execution

Meanwhile, the filter accuracy determination part 153 of the smoothing processing part 15 restricts the repeated execution by each of the filters 151 and 152 in order to prevent repeated execution of the smoothing processing by the edge-preserving smoothing filter 151 and the smoothing processing in the time direction by the temporal filter 152 from being performed without limitation.

That is, when the sum of absolute differences DM3 is not equal to or less than the threshold THI as a result of the determination in step S23, the filter accuracy determination part 153 counts the number of times of repeated execution C in step S24. Then, in step S25, it is determined whether the counted number of times of repeated execution C has reached an upper limit value TH2. For the upper limit value TH2, a value stored in advance in the threshold storage area in the data storage part 30 is used. If the number of times of repeated execution C does not reach the upper limit value TH2, the filter accuracy determination part 153 returns the depth map DM2 to the edge-preserving smoothing processing to be performed by the edge-preserving smoothing filter 151.

On the other hand, it is assumed that the number of times of repeated execution C after the count-up has reached the upper limit value TH2 as a result of the determination in step S25. In this case, the filter accuracy determination part 153 does not repeat smoothing processing further, and proceeds to step S26 to output the depth map DM2 as the corrected depth map DMout.

### Actions and Effects

As described above, in the video information processing apparatus 1 according to an embodiment, the smoothing processing part 15 includes the edge-preserving smoothing filter 151 and the temporal filter 152, and performs the edge-preserving smoothing processing by using the edge-preserving smoothing filter 151 and the smoothing processing in the time direction by using the temporal filter 152 on the depth map DMin estimated from the RGB image for each frame.

Thus, fluctuations on the depth map in the time direction in frames are reduced due to the smoothing processing in the time direction performed by the temporal filter 152, and even if the image quality becomes unsharp due to blur or fog occurring in the image of the edge portion of the object due to the smoothing processing by the temporal filter 152, the blur or fog of the image in the edge portion is reduced and the image quality becomes sharp through the edge-preserving smoothing processing by the edge-preserving smoothing filter 151. Therefore, it is possible to generate the depth map DMout in which blurring or the like in the image of the edge portions of the object is curbed and fluctuations in the interframe correlation are reduced. Moreover, motion prediction processing for each pixel block of the RGB image is unnecessary, and thereby the effect of improvement in the image quality can be obtained with a less processing load.

Furthermore, the filter accuracy determination part 153 is provided in the smoothing processing part 15, and the filter accuracy determination part 153 calculates the sum of absolute differences DM3 between the depth map DM2 output from the temporal filter 152 and the depth map DM1 that has undergone the edge-preserving smoothing processing by the edge-preserving smoothing filter 151 and before being input to the temporal filter 152, and repeatedly executes the edge-preserving smoothing processing by the edge-preserving smoothing filter 151 and the smoothing processing in the time direction by the temporal filter 152 on the depth map DM2 until the calculated sum of absolute differences DM3 becomes equal to or less than the threshold TH1.

Therefore, it is possible to generate the depth map DMout having good quality in which the image of the edge portion of the object is less blurred and sharp and the fluctuations of the interframe correlation is sufficiently suppressed.

In addition, the smoothing processing part 15, the filter accuracy determination part 153 counts the number of times of repeated execution C of the edge-preserving smoothing processing by the edge-preserving smoothing filter 151 and the smoothing processing in the time direction by the temporal filter 152, and the repeated execution ends when the number of times of repeated execution C reaches the upper limit value TH2. Therefore, it is possible to prevent a problem that the repeated execution is performed without limitation.

### Other Embodiments

(1) In the above embodiment, the filter accuracy determination part 153 of the smoothing processing part 15 compares the sum of absolute differences DM3 between the depth map DM1 output from the edge-preserving smoothing filter 151 and the depth map DM2 output from the temporal filter 152 with the threshold TH1, and at the time at which the sum of absolute differences DM3 becomes equal to or less than the threshold TH1, the depth map DM2 at that time is output as the smoothing-processed depth map DMout. However, the determination processing of the filter accuracy based on the sum of absolute differences DM3 is not necessarily performed, and for example, the smoothing processing by the edge-preserving smoothing filter 151 and the smoothing processing by the temporal filter 152 may be unconditionally and repeatedly performed by a preset number of times in an alternate manner, and the depth map DM2 obtained as a result may be output as the corrected depth map DMout.

(2) In general, in a case where a moving image includes a video effect in which an inter-frame correlation value of an object image greatly changes, such as a scene change or a crossfade, a sufficient smoothing effect cannot be obtained even if smoothing processing in the time direction is performed by a temporal filter. For this reason, for example, the video information processing apparatus 1 may receive detection information of a video effect in a moving image from the moving image generation apparatus 2, and perform control so that the smoothing processing in the time direction by the temporal filter is not performed on the frame in which the video effect has been detected based on the detection information.

(3) In the above embodiment, the case where the depth estimation processing of generating the depth map information from the input RGB image and the processing of generating the segmentation information of the image area including the object from the input RGB image are performed in the video information processing apparatus 1 has been described as an example. However, for example, in a case where the moving image generation apparatus 2 or another external apparatus has the function of generating the depth map information and the segmentation information, the video information processing apparatus 1 may acquire the depth map information and the segmentation information from the moving image generation apparatus 2 or the other external apparatus.

(4) Although the case where the depth map is generated from the RGB image extracted for each frame from the moving image has been described as an example in the above embodiment, a depth map may be generated from a two-dimensional moving image obtained by a monocular camera, or a depth map may be generated from a stereo image. Furthermore, a depth map may be generated from a monochrome image other than an RGB image.

(5) In the above embodiment, the case where the program for executing a series of processing operations according to the present invention is stored in advance in the program storage part 20 of the video information processing apparatus has been described as an example. However, in addition to this, the video information processing apparatus may read an application program from an external storage medium represented by a magnetic disk, an optical disk, or a semiconductor memory such as a USB memory as necessary or may download the application program from a server device or the like arranged on a web or a cloud as necessary and cause the control part 10 to execute the application program.

(6) In the above embodiment, the case where all of the processing functions according to the present invention are implemented by the one video information processing apparatus has been described. However, all of the processing functions according to the present invention may be distributed and arranged in a plurality of information processing apparatuses (e.g., a personal computer, a mobile terminal such as a smartphone, or a server device).

(7) In addition, the functional configuration of the video information processing apparatus, the processing procedures and processing details thereof, the type of moving image, and the like can be variously modified and implemented without departing from the gist of this invention.

Although the embodiments of the present invention have been described in detail above, the above description is merely an example of this invention in all respects. It is needless to say that various improvements and modifications can be made without departing from the scope of this invention. That is, a specific configuration according to the embodiments may be appropriately employed in carrying out the present invention.

In short, the present invention is not limited to the above-described embodiments without any change, and can be embodied by modifying the constituent elements without departing from the concept of the invention at the implementation stage. In addition, various inventions can be formulated by appropriately combining a plurality of the constituent elements disclosed in the above-described embodiments. For example, some constituent elements may be omitted from the entire constituent elements described in the embodiments. Furthermore, the constituent elements in different embodiments may be appropriately combined.

### REFERENCE SIGNS LIST

1 Video information processing apparatus
2 Moving image generation apparatus
3 Moving image display apparatus
10 Control part
11 RGB image acquisition processing part
12 Depth estimation processing part
13 Segmentation processing part
14 Size change processing part
15 Smoothing processing part
20 Program storage part
30 Data storage part
31 RGB image storage part
32 Depth map storage part
40 Input/output I/F part
50 Bus
151 Edge-preserving smoothing filter
152 Temporal filter
153 Filter accuracy determination part

1. A video information processing apparatus that generates a depth map of a moving image from the moving image, the video information processing apparatus comprising:
depth map information acquisition processing circuitry configured to acquire first depth map information generated for each of a plurality of frames constituting the moving image;
segmentation information acquisition processing circuitry configured to acquire segmentation information generated by dividing an image area including an object into a plurality of pixel blocks for each of the plurality of frames; and
smoothing processing circuitry configured to perform first filtering of performing edge-preserving smoothing on the first depth map information by using the segmentation information as a guide image for each of the plurality of frames and second filtering of smoothing, in a time direction, a pixel value of a pixel corresponding to a position in the first depth map information in the plurality of frames to generate corrected second depth map information.

2. The video information processing apparatus according to claim 1, wherein:
the smoothing processing circuitry repeatedly executes the first filtering and the second filtering in an alternate manner.

3. The video information processing apparatus according to claim 2, wherein:
the smoothing processing circuitry calculates a difference value between the first depth map information that has undergone the second filtering and the first depth map information that has undergone the first filtering but has not yet undergone the second filtering, and repeatedly executes the first filtering and the second filtering in an alternate manner until the calculated difference value becomes equal to or less than a preset threshold.

4. The video information processing apparatus according to claim 2, wherein:
the smoothing processing circuitry counts the number of times of repeated execution of the first filtering and the second filtering, and ends the repeated execution processing of the first filtering and the second filtering at a time at which the count value of the number of times of repeated execution reaches a preset upper limit value.

5. The video information processing apparatus according to claim 1, wherein:
when a video effect in which a correlation value of frames exceeding a predetermined amount is detected in the moving image, the smoothing processing circuitry does not perform the second filtering on the first depth map information generated for the frame in which the video effect is detected.

6. A video information processing method, comprising:
acquiring first depth map information generated for each of a plurality of frames constituting the moving image;
acquiring, for each of the plurality of frames, segmentation information generated by dividing an image area including an object into a plurality of pixel blocks; and
performing first filtering of performing edge-preserving smoothing on the first depth map information by using the segmentation information as a guide image for each of the plurality of frames and second filtering of smoothing, in a time direction, a pixel value of a pixel corresponding to a position in the first depth map information in the plurality of frames, to generate corrected second depth map information.

7. A non-transitory computer readable medium storing a program for causing a processor to perform the method of claim 6.
